(19) United States
(12) Patent Application Publication
(10) Pub. No.: US 2015/0038141 A1
(43) Pub. Date: Feb. 5, 2015

(54) METHOD OF REPORTING MEASUREMENT REPORT TRIGGERING EVENTS AND RELATED COMMUNICATION SYSTEM

(71) Applicant: ACER INCORPORATED, New Taipei City (TW)

(72) Inventor: Tsung-Yo Cheng, New Taipei City (TW)

(73) Assignee: ACER INCORPORATED, New Taipei City (TW)

(21) Appl. No.: 14/084,584

(22) Filed: Nov. 19, 2013

Related U.S. Application Data
(60) Provisional application No. 61/863,912, filed on Aug. 9, 2013.
(60) Provisional application No. 61/860,920, filed on Aug. 1, 2013.

(51) Int. Cl. H04W 36/00

(52) U.S. Cl. CPC H04W 36/0088
USPC 455/436

(57) ABSTRACT

A communication system includes a user equipment and a network having a serving cell and a neighboring cell. The user equipment receives network parameters from the network and stores a first UE-defined criteria associated with signals measured from the serving cell and the neighboring cell and a second UE-defined criteria associated with individual offsets of the serving cell and the neighboring cell. When the entering/leaving condition of a specific measurement report triggering event is satisfied, the user equipment is configured to report the specific measurement report triggering event to the network only when there is a considerable difference between measurement results of the neighboring cell and the serving cell and after determining that the network parameters have been set adequately.

### CROSS REFERENCE TO RELATED APPLICATIONS

This application claims the benefit of U.S. provisional application No. 61/862,093 filed on Aug. 5, 2013 and U.S. provisional application No. 61/863,912 filed on Aug. 9, 2013.

### BACKGROUND OF THE INVENTION

1. Field of the Invention

The present invention is related to a method of reporting measurement report triggering events and related communication system, and more particularly, to a method of operating a user equipment for reporting measurement report triggering events to a network and related communication system.

2. Description of the Prior Art

The 3rd Generation Partnership Project (3GPP) has developed a universal mobile telecommunications system (UMTS) which adopts a wideband code division multiple access (WCDMA) technology capable of providing high frequency spectrum utilization, universal coverage, and high-speed/quality multimedia data transmission. In the UMTS, a radio access network known as a universal terrestrial radio access network (UTRAN) includes multiple base stations, commonly known as Node-Bs (NBs), for communicating with multiple user equipment (UE). Furthermore, a long-term evolution (LTE) system is now being developed by the 3GPP in order to further improve performance of the UMTS to satisfy users' increasing needs. The LTE system includes a new radio interface and radio network architecture which provides a high data rate, low latency, packet optimization, and improved system capacity and coverage. In the LTE system, a radio access network known as an evolved UTRAN (E-UTRAN) includes multiple evolved NBs (eNBs) for communicating with multiple UEs and a core network which includes a mobility management entity (MME), a serving gateway and other devices for NAS (Non Access Stratum) control.

Mobility management in the above-mentioned communication systems mainly includes cell selection/reselection, handover and related measurements. Handover refers to the transfer process of management from a current serving cell to a target cell and is performed in all cellular mobile communication systems. The cells around a UE can be categorized in 3 different sets: active set, candidate set and monitored set. A cell of the active set is configured to establish connection with a mobile device during handover. A cell of the candidate set does not establish connection with a mobile device during handover, but its signal quality is qualified to be included in the active set. A cell of the monitor set does not have signal quality qualified to be included in the active set. The UE is configured to measure the signals from all cells within its communication range, determine whether a specific reporting event is satisfied and perform handover accordingly.

In the prior art, the network is configured to send measurement criteria to the UE via broadcast control channel (BCCH) for managing handover, radio bearer control (RBC) and positioning. The UE is then configured to evaluate whether the signals of the cells in the active set and the monitor set satisfy trigger conditions according the parameters provided by the network. The radio network controller (RNC) is notified when a trigger condition is satisfied for determining whether a corresponding handover should be performed. The measurement criteria may include network parameters, such as reporting range parameters, hysteresis parameters, and cell offset parameters. These network parameters are qualitatively defined in 3GPP specifications, but quantitative calculation or adjustment is performed and dynamically calibrated by the network according the geological environment and loading condition of the cells during setup stage.

In a cellular network, the Ping-Pong effect or the urban canyon effect is a very common phenomenon to degrade the network performance. The Ping-Pong effect occurs due to frequent movement of a UE between a cell pair, or high signal fluctuation at the common boundary of the cell pair. The urban canyon effect can be observed when high buildings hide the appropriate view of the sky, thus the geometry of satellites is poor for determining the current position of the UE. Therefore, the network parameters broadcast by two neighboring cells A and B may be set to encourage the UE to handover to either the cell A or B when moving near the common boundary of the cells A and B. However, while the network setting may be adequate when the UE is moving in a direction from the cell A to the cell B, it becomes inadequate when the UE is moving in a reverse direction from the cell B to the cell A. The UE may trigger the measurement report event inadequately, thereby causing unnecessary handover and increasing call drop rate.

### SUMMARY OF THE INVENTION

The present invention provides a method of operating a user equipment for reporting measurement report triggering events to a network. The method includes storing a first UE-defined criteria and a second UE-defined criteria in the user equipment, wherein the first UE-defined criteria is associated with signals measured from a first cell and a second cell within the network, and the second UE-defined criteria is associated with individual offsets of the first cell and the second cell; the user equipment receiving a plurality of network parameters from the network; the user equipment acquiring a first measurement result of the first cell and a second measurement result of the second cell when camping on the first cell; the user equipment determining whether a specific measurement report triggering event is satisfied according to the first measurement result, the second measurement result, and at least one of the plurality of network parameters; the user equipment determining whether the first UE-defined criteria or the second UE-defined criteria is satisfied according to the first measurement result, the second measurement result, and at least one of the plurality of network parameters; and when the specific measurement report triggering event is satisfied, the user equipment reporting the specific measurement report triggering event to the network at determining that at least one of the first UE-defined criteria and the second UE-defined criteria is satisfied.

The present invention also provides a communication system for reporting measurement report triggering events. The communication system includes a network having a first cell and a second cell; and a user equipment including a network connectivity unit configured to receive a plurality of network parameters and a measurement configuration from the network; a measuring unit configured to acquire a first measurement result of the first cell and a second measurement result of the second cell according to the measurement configuration when the user equipment is camping on the first cell; a memory unit for storing a first UE-defined criteria and a second UE-defined criteria, wherein the first UE-defined criteria is associated with signals measured from the first cell and the second cell, and the second UE-defined criteria is associated with individual offsets of the first cell and the second cell; and a processing component configured to determine whether a specific measurement report triggering event is satisfied according to the first measurement result, the second measurement result, and at least one of the plurality of network parameters; determine whether the first UE-defined criteria or the second UE-defined criteria is satisfied according to the first measurement result, the second measurement result, and at least one of the plurality of network parameters when the specific measurement report triggering event is satisfied; and instruct the measuring unit to report the specific measurement report triggering event to the network when the specific measurement report triggering event is satisfied and at least one of the first UE-defined criteria and the second UE-defined criteria is satisfied.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a method of operating a UE for reporting measurement report triggering events to a network according to an embodiment of the present invention.

FIG. 2 is a functional diagram illustrating an embodiment of a UE configured to carry out the present method illustrated in FIG. 1.

### DETAILED DESCRIPTION

In the present invention, a network is configured to broadcast network parameters to a UE and the UE is configured to measure the parameters of the serving cell and a neighboring cell. The UE is then configured to determine whether a specific event should be reported to the network according to the measurement result of the serving cell, the measurement result of the neighboring cell, the network parameters received from the network, and at least one UE-defined criteria.

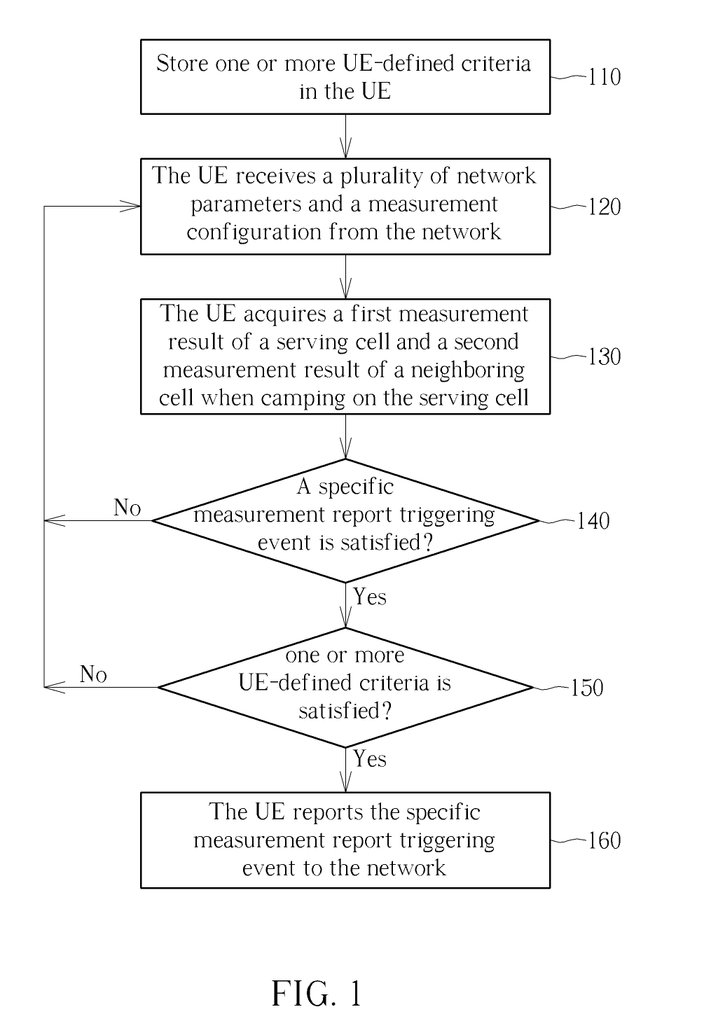

FIG. 1 is a flowchart illustrating a method of operating a UE for reporting measurement report triggering events to a network according to an embodiment of the present invention. The flowchart in FIG. 1 includes the following steps:

Step 110: store one or more UE-defined criteria in the UE; execute step 120.

Step 120: the UE receives a plurality of network parameters and a measurement configuration from the network; execute step 130.

Step 130: the UE acquires a first measurement result of a serving cell and a second measurement result of a neighboring cell when camping on the serving cell; execute step 140.

Step 140: the UE determines whether a specific measurement report triggering event is satisfied according to the first measurement result, the second measurement result, and one or multiple network parameters; if yes, execute step 150; if no, execute step 120.

Step 150: the UE determines whether one or more UE-defined criteria are satisfied according to the first measurement result, the second measurement result, and one or multiple network parameters; if yes, execute step 160; if no, execute step 120.

Step 160: the UE reports the specific measurement report triggering event to the network.

According to the 3GPP specification TS 25.331, UE measurements can be categorized into seven types: intra-frequency measurements, inter-frequency measurements, inter-RAT measurements, traffic volume measurements, quality measurements, UE internal measurements, and UE positioning measurements.

Intra-frequency measurement includes 9 reporting events defined as follows:

Event 1A: a primary common pilot channel (CPICH) enters the reporting range;

Event 1B: a primary CPICH leaves the reporting range;

Event 1C: a non-active primary CCPCH becomes better than an active primary CCPCH;

Event 1D: change of best cell;

Event 1E: a primary CCPCH becomes better than an absolute threshold; and

Event 1F: a primary CCPCH becomes worse than an absolute threshold;

Event 1G: change of best cell;

Event 1H: timeslot interference signal code power (ISCP) below a certain threshold;

Event 1I: timeslot ISCP above a certain threshold.

Inter-frequency measurement includes 6 reporting events defined as follows:

Event 2A: change of best frequency;

Event 2B: the estimated quality of the currently used frequency is below a certain threshold and the estimated quality of a non-used frequency is above a certain threshold;

Event 2C: the estimated quality of a non-used frequency is above a certain threshold;

Event 2D: the estimated quality of the currently used frequency is below a certain threshold;

Event 2E: the estimated quality of a non-used frequency is below a certain threshold; and

Event 2F: the estimated quality of the currently used frequency is above a certain threshold.

Inter-RAT measurement includes 4 reporting events defined as follows:

Event 3A: the estimated quality of the currently used UTRAN frequency is below a certain threshold and the estimated quality of the other system is above a certain threshold;

Event 3B: the estimated quality of other system is below a certain threshold;

Event 3C: the estimated quality of other system is above a certain threshold.

Event 3D: change of best cell in other system

Traffic volume measurement includes 2 reporting events defined as follows:

Event 4A: transport channel traffic volume exceeds an absolute threshold; and

Event 4B: transport channel traffic volume becomes smaller than an absolute threshold.

Quality measurement includes 1 reporting event defined as follows:

Event 5A: a predefined number of bad cycle redundancy checks (CRCs) is exceeded.

UE internal measurement includes 7 reporting events defined as follows:

Event 6A: the UE transmitting power becomes larger than an absolute threshold;

Event 6B: the UE transmitting power becomes less than an absolute threshold;

Event 6C: the UE transmitting power reaches its minimum value;

Event 6D: the UE transmitting power reaches its maximum value;

Event 6E: the UE received signal strength indicator (RSSI) reaches the UE's dynamic receiver range;

Event 6F: the UE receiving-transmitting time difference becomes larger than an absolute threshold; and

Event 6G: the UE receiving-transmitting time difference becomes smaller than an absolute threshold.

UE positioning measurement includes 7 reporting events defined as follows:

Event 7A: the UE position changes more than an absolute threshold;

Event 7B: SFN-SFN (single frequency network) measurement changes more than an absolute threshold;

Event 7c: global positioning system (GPS) time and SFN time have drifted apart more than an absolute threshold.

Event 7d: Galileo and additional navigation satellite systems (GANSS)time and SFN time have drifted apart more than an absolute threshold.

According to the 3GPP specification TS 36.331, there are 8 types of measurement report triggering event based on the above-mentioned UE measurements defined in the 3GPP specification TS 25.331.

Event A1: serving becomes better than threshold;

Event A2: serving becomes worse than threshold;

Event A3: neighbor becomes offset better than primary cell (PCell);

Event A4: neighbor becomes better than threshold;

Event A5: Pcell becomes worse than threshold1 and neighbor becomes better than threshold2;

Event A6: neighbor becomes offset better than secondary cell (SCell);

Event B1: Inter RAT neighbor becomes better than threshold; and

Event B2: Pcell becomes worse than threshold1 and inter RAT neighbor becomes better than threshold2.

For explanation purpose, Event A3 is used for illustrating the present invention. According to the 3GPP specification TS 36.331, the entering condition of Event A3 is considered to be satisfied when the condition specified by the following equation (1) is fulfilled, while the leaving condition of Event A3 is considered to be satisfied when the condition specified by the following equation (2) is fulfilled.

Mn+Ofn+Ocn−Hys>Mp+Ofp+Ocp+Off (1)

Mn+Ofn+Ocn+Hys<Mp+Ofp+Ocp+Off (2)

In step 110, the one or more UE-defined criteria associated with Event A3 are stored in the UE. Regarding the entering condition of Event A3, a first UE-defined criteria may be specified by the following equation (3), while a second UE-defined criteria may be specified by the following equation (4):

Mn−Mp−Hys>Tres1 (3)

|Ocn−Ocp|<Tres2 (4)

Regarding the leaving condition of Event A3, a third UE-defined criteria maybe specified by the following equation (5), while a fourth UE-defined criteria may be specified by the following equation (6):

Mn−Mp+Hys<Tres3 (5)

|Ocn−Ocp|>Tres4 (6)

In the above-mentioned equations (1)-(6), Ofn, Ocn, Ofp, Ocp, Hys and Off represent the network parameters signaled from the network to the UE in step 120. Ofn is the frequency specific offset of the frequency of the neighboring cell. Ocn is the cell specific offset of the neighboring cell. Ofp is the frequency specific offset of the primary frequency. Ocp is the cell specific offset of the serving cell. Hys is the hysteresis parameter for Event A3. Off is the offset parameter for Event A3.

Also in step 120, the UE is configured to receive the measurement configuration from the network by means of dedicated signaling, typically using the RRCConnectionReconfiguration message in RRC-CONNECTED mode. The measurement configuration provided to the UE may include parameters required for performing minimizing drive test (MDT), such as measurement objects, reporting configurations, measurement identities, quantity configurations, and measurement gaps. Based on the measurement configuration received in step 120, the UE may then acquire the first measurement result of the serving cell and the second measurement result of the neighboring cell when camping on the serving cell in step 130.

In equations (1), (2), (3) and (5), Mp represents the first measurement result of the serving cell acquired instep 130, not taking into account any offsets. Mn represents the second measurement result of the neighboring cell acquired in step 130, not taking into account any offsets. The first measurement result Mp and the second measurement result Mn may be acquired by performing one or more of the above-mentioned intra-frequency measurements, inter-frequency measurements, inter-RAT measurements defined in the 3GPP specification TS 25.331.

In equations (3)-(4), Tres1-Tres4 represent UE-defined threshold values which may be set at the manufacturing stage of the UE or by the user.

In step 140, the UE is configured to determine whether Event A3 is satisfied according to equation (1) or (2) . If none of the entering condition of Event A3 specified by equation (1) and the leaving condition of Event A3 specified by equation (2) is satisfied, the UE does not report Event A3 and loops back to step 120. If any of the entering condition of Event A3 specified by equation (1) and the leaving condition of Event A3 specified by equation (2) is satisfied, step 150 is then executed.

In a first embodiment of the present invention, step 150 is executed according to the first UE-defined criteria specified by equations (3) when the entering condition of Event A3 specified by equation (1) is satisfied, or according to the third UE-defined criteria specified by equations (5) when the leaving condition of Event A3 specified by equation (2) is satisfied. When the measurement result of the neighboring cell Mn is worse than the measurement result of the serving cell Mp or is only slightly better than the measurement result of the serving cell Mp (Mn−Mp−Hys>0), equation (1) may still be satisfied if the network parameters Ofn, Ocn, Ofp and Ocp have been set inadequately; when the measurement result of the neighboring cell Mn is better than the measurement result of the serving cell Mp or is only slightly worse than the measurement result of the serving cell Mp (Mn−Mp+Hys<0), equation (2) may still be satisfied if the network parameters Ofn, Ocn, Ofp and Ocp have been set inadequately. Under such circumstances, the introduction of Equation (3) allows the UE to report Event A3 in step 160 only when the measurement result of the neighboring cell Mn is considerably better than the measurement result of the serving cell Mp (Mn−Mp−Hys>Tres1) regarding the entering condition, while the introduction of Equation (5) allows the UE to report Event A3 in step 160 only when the measurement result of the neighboring cell Mn is considerably worse than the measurement result of the serving cell Mp (Mn−Mp+Hys<Tres3) regarding the leaving condition. Therefore, the present invention may reduce call drop rate since the UE only performs necessary and proper handovers.

In a second embodiment of the present invention, step 150 is executed according to the second UE-defined criteria specified by equations (4) when the entering condition of Event A3 specified by equation (1) is satisfied, or according to the fourth UE-defined criteria specified by equations (6) when the leaving condition of Event A3 specified by equation (2) is satisfied. When the measurement result of the neighboring cell Mn is worse than the measurement result of the serving cell Mp or is only slightly better than the measurement result of the serving cell Mp (Mn−Mp−Hys>0), equation (1) may still be satisfied if the network parameters Ofn, Ocn, Ofp and Ocp have been set inadequately; when the measurement result of the neighboring cell Mn is better than the measurement result of the serving cell Mp or is only slightly worse than the measurement result of the serving cell Mp (Mn−Mp+Hys<0), equation (2) may still be satisfied if the network parameters Ofn, Ocn, Ofp and Ocp have been set inadequately. Under such circumstances, the introduction of equation (4) allows the UE to determine whether the network parameters associated with cell individual offset have been set properly. If the difference between the cell specific offset of the neighboring cell Ocn and the cell specific offset of the serving cell Ocp does not exceed the UE-defined threshold value Tres2 or Tres4, the UE may determine that the network parameters have been set adequately and proceeds to report Event A3 in step 160 when equation (1) or (2) is satisfied; if the difference between the cell specific offset of the neighboring cell Ocn and the cell specific offset of the serving cell Ocp exceeds the UE-defined threshold Tres2 or Tres4, the UE may determine that the network parameters have been set inadequately and does not report Event A3 even when equation (1) or (2) is satisfied. Therefore, the present invention may reduce call drop rate since the UE only performs necessary and proper handovers.

In a third embodiment of the present invention, step 150 is executed according to both the first UE-defined criteria specified by equations (3) and the second UE-defined criteria specified by equations (4) when the entering condition of Event A3 specified by equation (1) is satisfied, or according to both the third UE-defined criteria specified by equations (5) and the fourth UE-defined criteria specified by equations (6) when the leaving condition of Event A3 specified by equation (2) is satisfied. Similar to the above-mentioned first and second embodiments, the introduction of equation (3) and (4) in the third embodiment of the present invention allows the UE to report Event A3 in step 160 only when the measurement result of the neighboring cell Mn is considerably better than the measurement result of the serving cell Mp and after determining that the network parameters have been set adequately regarding the entering condition, while the introduction of equations (5) and (6) allows the UE to report Event A3 in step 160 only when the measurement result of the neighboring cell Mn is considerably worse than the measurement result of the serving cell Mp and after determining that the network parameters have been set adequately regarding the leaving condition. Therefore, the present invention may reduce call drop rate since the UE only performs necessary and proper handovers.

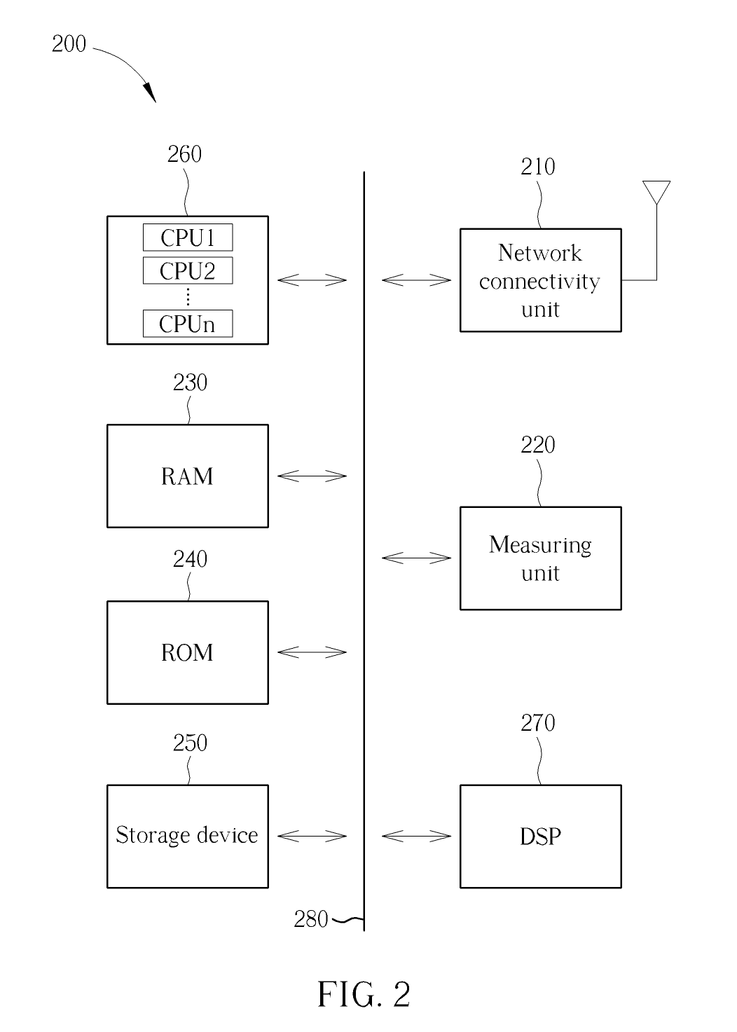

In the present invention, the UE may include transportable electronic devices, such as mobile telephones, personal digital assistants, handheld, tablet, nettop, or laptop computers, or other devices with similar telecommunication capabilities. FIG. 2 is a functional diagram illustrating an embodiment of a UE 200 configured to carry out the present method illustrated in FIG. 1. The UE 200 includes a network connectivity unit 210, a measuring unit 220, random access memory (RAM) 230, read only memory (ROM) 240, a storage device 250, a processing component 260, and a digital signal processor (DSP) 270. These components might communicate with one another via a bus 280. In some cases, some of these components may not be present or maybe combined in various combinations with one another or with other components not shown. These components might be located in a single physical entity or in more than one physical entity. Any actions described herein as being taken by the processing component 260 may be taken by the processing component 260 alone or by the processing component 260 in conjunction with one or more components shown or not shown in the drawing, such as with the DSP 270. Although the DSP 270 is shown as a separate component, the DSP 270 might be incorporated into the processing component 260.

The network connectivity unit 210 may include one or multiple modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, GSM/UMTS/LTE radio transceiver devices, worldwide interoperability for microwave access (WiMAX) devices, and/or other well-known devices for connecting to other network entities. The network connectivity unit 210 allows the processing component 260 to communicate with the Internet or one or more telecommunications networks (not shown) for receiving network parameters and the measurement configuration.

The measuring unit 220 is configured to perform MDT measurements for acquiring the first measurement result and the second measurement result according to the measurement configuration. The measuring unit 220 is also configured to report a specific measurement report triggering event in step 160 when instructed by the processing component 260.

The RAM 230 may be used to store volatile data and instructions that are executed by the processing component 260. The ROM 240 may be used to store instructions and data that are read during execution of the instructions. The storage device 250 may include various disk-based systems such as hard disk, floppy disk, or optical disk and may be used to store programs that are loaded into the RAM 230 when such programs are selected for execution. Access to both the RAM 230 and the ROM 240 is typically faster than access to the storage device 250, but the storage device 250 can provide larger memory capacity. In steps 110-130 of the present invention, the UE-defined criteria, the network parameters, the measurement configuration and the measurement results may be stored in the available memory space of the RAM 230, ROM 240 and/or the storage device 250.

The processing component 260 is configured to execute instructions, codes, computer programs, or scripts which may be accessed from the network connectivity units 220, RAM 230, ROM 240, or the storage device 250, such as performing the determination processes in steps 140 and 150. The processing component 260 may include one or multiple processors CPU1˜CPUn for executing the present method simultaneously, serially, or otherwise by one processor. Also, the processing component 260 is configured to instruct the measuring unit 220 to execute step 160 according to the result of steps 140 and 150.

Although Event A3 is used for illustrative purpose in the present disclosure, the present invention maybe applied to any type of the measurement report triggering events defined in the 3GPP specification TS 25.331. The UE-defined criteria associated with the entering/leaving condition of each measurement report triggering event may be identical or set separately (different Tres1-Tres4 for different measurement report triggering events).

In the present invention when the entering/leaving condition of a specific measurement report triggering event is satisfied, the introduction of the UE-defined criteria allows the UE to report the specific measurement report triggering event only when there is a considerable difference between the measurement results of the neighboring cell and the serving cell and after determining that the network parameters have been set adequately Therefore, the present invention may reduce call drop rate since the UE only performs necessary and proper handovers.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of operating a user equipment (UE) for reporting measurement report triggering events to a network, comprising:
storing a first UE-defined criteria and a second UE-defined criteria in the user equipment, wherein the first UE-defined criteria is associated with signals measured from a first cell and a second cell within the network, and the second UE-defined criteria is associated with individual offsets of the first cell and the second cell;
the user equipment receiving a plurality of network parameters from the network;
the user equipment acquiring a first measurement result of the first cell and a second measurement result of the second cell when camping on the first cell;
the user equipment determining whether a specific measurement report triggering event is satisfied according to the first measurement result, the second measurement result, and at least one of the plurality of network parameters;
the user equipment determining whether the first UE-defined criteria or the second UE-defined criteria is satisfied according to the first measurement result, the second measurement result, and at least one of the plurality of network parameters; and
when the specific measurement report triggering event is satisfied, the user equipment reporting the specific measurement report triggering event to the network at determining that at least one of the first UE-defined criteria and the second UE-defined criteria is satisfied.

2. The method of claim 1, wherein the specific measurement report triggering event is any of Events A1-A6 and B1-B2 defined in a 3rd Generation Partnership Project (3GPP) specification TS 36.331.

3. The method of claim 1, wherein the first measurement result and the second measurement result are acquired in an intra-frequency measurement, an inter-frequency measurement, or an inter-RAT measurement of the first cell and the second cell defined in a 3GPP specification TS 25.331.

4. The method of claim 1, further comprising:
setting a first UE-defined threshold value, wherein the first UE-defined criteria is satisfied when an absolute value of a difference between the first measurement result and the second measurement result is greater than the first UE-defined threshold value.

5. The method of claim 1, further comprising:
setting a second UE-defined threshold value, wherein:
the plurality of network parameters includes a cell specific offset of the first cell and a cell specific offset of the second cell; and
the second UE-defined criteria is satisfied when an absolute value of a difference between the cell specific offset of the first cell and the cell specific offset of the second cell is smaller than the second UE-defined threshold value.

6. The method of claim 1, wherein the plurality of network parameters includes a frequency specific offset of a frequency of the first cell, a frequency specific offset of a frequency of the second cell, a cell specific offset of the first cell, a cell specific offset of the second cell, a hysteresis parameter for the specific measurement report triggering event, or an offset parameter for the specific measurement report triggering event.

7. The method of claim 1, further comprising:
the specific measurement report triggering event is satisfied when.

8. A communication system for reporting measurement report triggering events comprising:
a network having a first cell and a second cell; and
a user equipment including:
a network connectivity unit configured to receive a plurality of network parameters and a measurement configuration from the network;
a measuring unit configured to acquire a first measurement result of the first cell and a second measurement result of the second cell according to the measurement configuration when the user equipment is camping on the first cell;
a memory unit for storing a first UE-defined criteria and a second UE-defined criteria, wherein the first UE-defined criteria is associated with signals measured from the first cell and the second cell, and the second UE-defined criteria is associated with individual offsets of the first cell and the second cell; and
a processing component configured to:
determine whether a specific measurement report triggering event is satisfied according to the first measurement result, the second measurement result, and at least one of the plurality of network parameters;
determine whether the first UE-defined criteria or the second UE-defined criteria is satisfied according to the first measurement result, the second measurement result, and at least one of the plurality of network parameters when the specific measurement report triggering event is satisfied; and
instruct the measuring unit to report the specific measurement report triggering event to the network when the specific measurement report triggering event is satisfied and at least one of the first UE-defined criteria and the second UE-defined criteria is satisfied.
